(19) United States
(12) Patent Application Publication
(10) Pub. No.: US 2015/0278899 A1
(43) Pub. Date: Oct. 1, 2015

(54) System and Method for Providing Customer' Answers to Prospects' Questions In Digital Media

(71) Applicant: Robert G. Fuggetta, Belmont, CA (US)

(72) Inventor: Robert G. Fuggetta, Belmont, CA (US)

(21) Appl. No.: 14/675,617

(22) Filed: Mar. 31, 2015

Related U.S. Application Data
(60) Provisional application No. 61/973,660, filed on Apr. 1, 2014.

(51) Int. Cl. G06Q 30/06; G06Q 50/00; G06Q 30/02

(52) U.S. Cl. CPC G06Q 30/0613; G06Q 30/0281; G06Q 50/01

(57) ABSTRACT

A system and method are disclosed for providing customers' answers to prospects' questions in digital media.

### CROSS-REFERENCE TO RELATED APPLICATION

This application claims priority to U.S. Provisional Application No. 61/973,660, entitled “System and Method for Providing Customers' Answers to Prospects' Questions In Digital Media,” filed on Apr. 1, 2014, the entire contents of which are incorporated herein by reference.

### TECHNICAL FIELD

This disclosure relates generally to digital marketing and advertising.

### BACKGROUND

A “brand advocate” is a term used in electronic commerce and online advertising to describe a person or customer who talks favorably about a brand or product and then passes on positive word-of-mouth messages about the brand to other people. Brand advocates are more influential than an average customer. Often a positive experience with a brand or successful customer-service relationship motivates a brand advocate to express their positive feelings towards a brand to other potential customers. A brand advocate performs functions higher than that of a testimonial and much lower than that of a promotional model or brand ambassador, since brand advocacy implies active participation with the brand involved. Social media tools allow a brand advocate to recommend brands on websites, social networks, blogs and other online forums.

### SUMMARY

A system and method is disclosed that enables prospects for purchasing a branded product or service to ask brand advocates (hereinafter also referred to as “customers”) questions about their experiences with the brand, company, prospect, or service. By enabling prospects to ask brand advocates questions, the system and method is intended to increase a brand's sales and marketing effectiveness by generating sales leads, assisting with customer acquisition, re-engaging and possibly converting “lost prospects” (i.e., prospects who engaged with the brand in some way, such as visiting the brand's website; downloading information; or who abandoned the online purchase process (an online consumer behavior known as “shopping cart abandonment”), encouraging current customers to buy additional products and services (generally known as “up-sell” and “cross-sell”) with the specific purpose of generating sales leads and driving customer acquisition. In some implementations, some companies may want all customers—not only brand advocates—to have an opportunity to answer prospects' questions. The system and method can be configured accordingly for such implementations.

The details of the disclosed implementations are set forth in the accompanying drawings and the description below. Other features, objects and advantages are apparent from the description, drawings and claims.

### DESCRIPTION OF DRAWINGS

FIG. 1 illustrates an example process for providing customers' answers to prospects questions in digital media.

FIG. 2 is a block diagram of an example advocate ad system for performing the process of FIG. 1.

The same reference symbol used in various drawings indicates like elements.

### DETAILED DESCRIPTION

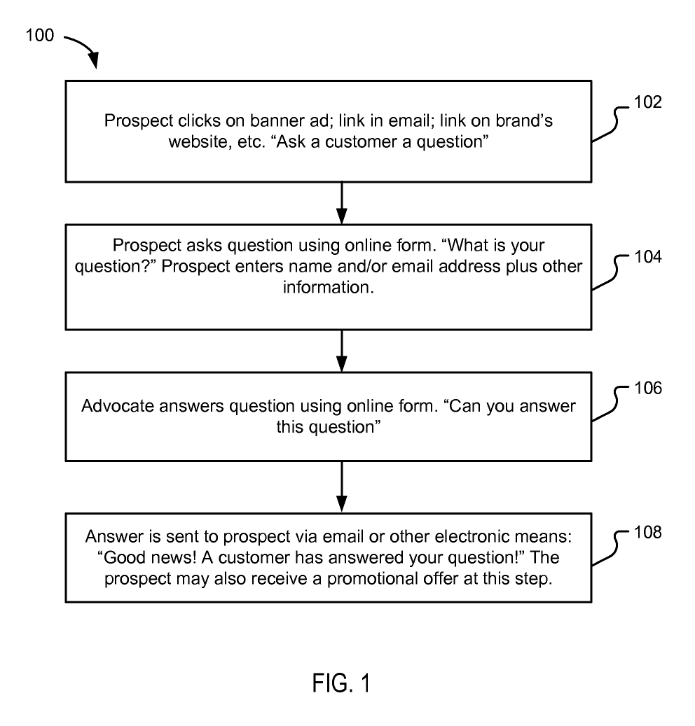

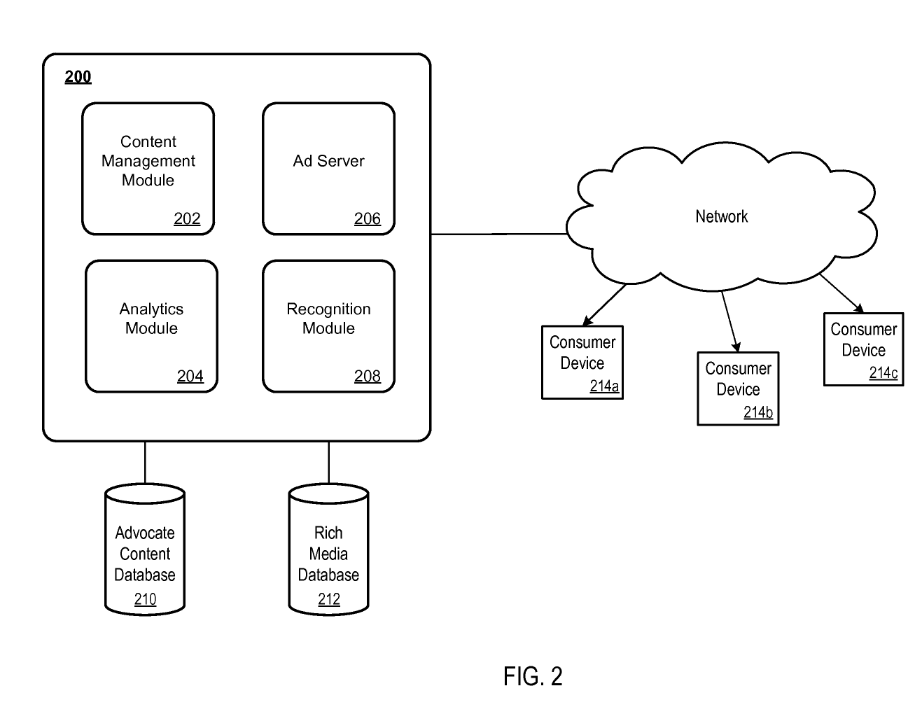

FIG. 1 illustrates an example process 100 for providing customers' answers to prospects' questions in digital media (e.g., web page, email, text message). The process 100 can be implemented by the system shown in FIG. 2.

In step 102, a prospect clicks on or touches (if using a device with a touch sensitive screen or surface) an ad unit or user interface element. For example, the user can click on or touch an online ad unit (e.g., banner ad, paid search ad), a marketing email, a banner or link on a brand's website or other online content inviting prospects to ask customers questions. For example, an ad unit can include the text “would you like to ask a customer a question about our company, products, or services?” The prospect may be using a computer, smart phone, or any device that accesses content online.

In step 104, the prospect is invited to ask a customer a question about their experience with the company, brand, product or service using an online form (e.g., a “web page”). The question may be in the form of a written question, a video, a voice recording or other electronic means. To ask a question, the prospect may be asked to provide or confirm profile information about themself and other information. This information may include without limitation: the prospect's name; gender; age; email address; Twitter™ handle; phone number; street address; which of the company's products or services they're interested in and/or considering buying; how they intend to use the product or service; company; job title; industry; role and responsibilities; expected timing for purchase; or other information. The prospect may be invited to provide a photo of him or herself. The information that the prospect provides can become a sales lead.

After completing the required information in the online form, the prospect clicks or touches the “submit” button or other user interface element and their question is routed by the system to candidate customers through email or other electronic means. In some implementations, the prospect is notified that they will receive answers to their questions within a certain time period, such as 24 or 48 hours. In some implementations, the system is configured to allow the prospect to immediately engage with a customer to get an answer to the prospect's question. For example the question “would you like to talk to a customer now?” could be presented to the prospect. This immediate engagement may occur over email, text, phone call or other electronic means. In some implementations, a live “chat” or text session between the prospect and customer can be established automatically by the system with an option to join.

In some implementations, prior to the question being sent electronically to customers, the system may allow the brand, company, agency or other organization to review the question and then approve it to be sent to customers. The system can be configured to automatically delete or suspend questions that are offensive, vulgar, or that the brand deems inappropriate.

As soon as the prospect submits his/her question, the prospect receives an acknowledgement which can include but is not limited to an electronic pop-up, email or other electronic means their question has been received and sent to customers. At the same time or at a later time, the prospect may receive a promotional offer or other commercial message from the company or brand, which may induce the prospect at that time to learn more about the company, product, or service and/or engage with the brand in some other way.

In step 106, one or more customers are selected to automatically receive notification that a prospect has asked a question. The notification sent to the selected customers may include but is not limited to: an email; a text message; an alert on a customer dashboard; or other electronic notification. Once a customer receives such notification, the customer is invited to answer the prospect's question. For example, the customer may be presented with the text “can you answer this question?” In some implementations, the system can be configured to determine which customers gets the questions (all customers or some customers), how often customers receive questions, how many questions they receive, what type of questions customers receive, which customers receive which types of questions, how the questions should be sent to customers (e.g., email, text), etc.

In some implementations, customers are selected to answer prospects questions based on shared characteristics with the prospect. Some shared characteristics include but are not limited to: the customer resides in the same zip code as the prospect, the customer has a profile similar to the prospect's profile, the customer has a similar demographic (e.g., age, gender) as the prospect, the customer has similar likes or dislikes as the prospect (e.g., Facebook™ likes or dislikes) or the customer having similar hobbies or interests as the prospect. In implementations where the prospect is using a location aware device, the prospect's current location (e.g., GPS coordinates) can be used to select the customer to receive the question from the prospect. The location of the prospect can be determined using any known positioning technology, including but not limited to: satellite-based (e.g., GPS) and network-based (e.g., Wi-Fi, cellular, Bluetooth) positioning systems.

The answer may be in the form of a written answer using an online form including but not limited to: a web page; video; voice recording; or other electronic means. In addition to answering the question, the customer may be asked to provide a photo of him or herself. In addition, the customer may be asked to provide or confirm information about themself including but not limited to: name; gender; age; email address; Twitter™ handle; phone number; street address; which of the company's products or services they own or have owned; how they use the company's products or services; how long they've been a customer of the company; their job title; company; industry; or other information.

In some implementations, some of the customer information may be pulled automatically from a customer relationship management (CRM) system, customer database or any other electronic system that stores customer information. After the completing the required information in the online form, the customer clicks or touches a “submit” button or other user interface element and their answer is routed by the system to the prospect who has asked the question through email or other electronic means. In some implementations, prior to the answer being sent electronically to the prospect, the system may allow the brand, company, agency or other organization to review the answer and then approve that the answer be sent to the prospect. The system can be configured to automatically delete or suspend answers that are offensive, vulgar, or that the brand deems inappropriate.

After submitting the answer, the customer can receive an acknowledgement including but not limited to: an electronic pop-up; email; or other electronic means that his/her answer has been received and sent to prospects. At the same time or at a later time, the customer may receive a promotional offer or other commercial message from the company or brand, which may induce the customer at that time to learn more about the company, product, or service and/or engage with the brand in some other way. The customer also may receive rewards or other incentives or acknowledgement for answering prospects' questions. Examples of incentives can include but are not limited to: points that can be redeemed for gifts; donations to charitable causes; or other incentives and acknowledgement.

In step 108, the system automatically sends the answer(s) to the prospect. This may be done via email, text message, or other electronic means. The answer displays certain profile information and other information about the customer who has answered the question. This information may include but is not limited to: a photograph of the customer; their name or an abbreviation of their name; how long they have been a customer of the company; which of the company's products or services they use; where they reside; what company they work for and their job title. The system also may display further information about the customer, such as how many questions they've answered, what percentage of prospects rate the customer's answers as helpful and other information that enables the prospect to learn more about the customer that has answered the question.

In addition to the answer and information about the customer, the prospect may also receive a promotional offer or other commercial message from the company or brand, which may induce the prospect at that time to learn more about the company, product, or service and/or engage with the brand in some other way. If the prospect clicks through to learn more or take further action, the system automatically tracks this action using online analytics. The prospect may also be provided an opportunity to rate the answer in some way. For example, the prospect can be presented with the text “was this answer helpful? Yes or no?” The prospect may also be provided the opportunity to flag the answer as inappropriate by pressing a button, checking a box or by other means.

As the above-described question/answer interaction occurs between customers and prospects, the system automatically captures and analyzes information about this interaction including but not limited to: how many prospects have asked questions; what is the profile of these prospects at the individual and aggregate level; what are the questions that have been asked; when are prospects asking questions; which method are they using to ask questions (e.g., filling out an online form, creating a video, voice recording); which products and services are they asking about; other information about prospects such as whether the prospect clicked on a promotional offer included with the answer and whether the consumer purchased a product or service associated with the promotional offer. This information may be automatically entered into a prospect database.

Additionally, interaction information also may be presented to companies via an online dashboard or other online analytics tool. At the same time, the system can automatically capture information about customers who answer questions, including but not limited to: how many customers have answered questions; what is the profile of these customers at the individual and aggregate level; what are the answers that have been provided; when are customers answering questions; which method are they using to answer questions (e.g., filling out an online form, creating a video, voice recording); which products and services are they answering questions; on average, how many answers are provided to prospects per question; plus other information about customers. This captured information may be automatically entered into a customer database and presented to companies through an online dashboard or other online analytics tool.

In addition to generating sales leads and driving customer acquisition, the content created by prospects and customers in this process (e.g., the questions asked by prospects the answers provided by customers) can be used to further advance companies sales and marketing goals and objectives by displaying this content on the brands' website, in paid media advertising campaigns, in email marketing campaigns, on their social channels (e.g., Facebook™, Twitter™, Linkedln™) and elsewhere.

Additionally, this content can be useful for other purposes, such as providing feedback and insights that can help inform a company's product designers and developers, professionals responsible for driving customer satisfaction and/or customer/brand loyalty and others responsible for customer experience. The system can be configured to enable these constituencies to access this content and access reports and analyses of this content.

FIG. 2 is a block diagram of an example advocate ad system 200 for performing process 100, as described in reference to FIG. 1. In some implementations, system 200 can include content management module 202, analytics module 204, ad server 206 and recognition module 208. Coupled to advocate ad system 200 is advocate content database 210 and rich media database 212. Various components of advocate ad system 200 can be implemented on one or more server computers coupled to a wide area network (e.g., Internet) or other network that is coupled (wired or wirelessly) to multiple consumer devices (e.g., smart phone, e-tablet, wearable device, notebook computer, television system, kiosk) either directly or through a local area network (e.g., Wi-Fi, cellular, Bluetooth). Databases 210 and 212 can be implemented as a single database or several databases.

Content management module 202 is configured to obtain and store advocate endorsements and manage question and answer interactions between prospects and customers using process 100. In some implementations, a separate module can be used to manage question and answer interactions. Analytics module 204 is configured to track and analyze results, such as a click-through rate for an ad, conversion rates, other metrics used to determine the success of a particular ad or ad campaign, including metrics resulting from process 100. Ad server 206 is configured to serve advocate endorsements to consumers and questions and answers to prospects and customers. In some implementations, separate servers can be used to serve advocate endorsements and questions and answers. Recognition module 210 is configured to recognize the consumer and provide relevant advocate endorsements to consumers. The consumer can be recognized through an HTTP cookie or profile information provided by the consumer, such as the zip code of where the consumer resides, the consumer's current location; area code, gender, hobbies or interests, likes or dislikes or any other information that can be used to recognize the consumer.

Advocate content database 210 stores advocate content such as endorsements as well as question/answer interaction content as described in reference to FIG. 1. Rich media database 212 stores digital media units that have been enriched by the advocate information, such as a dynamic banner add that includes a link to a landing page with one or more advocate endorsements. In some implementations, separate databases can store question/answer interaction content and advocate content.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. The systems and techniques presented herein are also applicable to other electronic text such as electronic newspaper, electronic magazine, electronic documents etc. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
presenting an invitation to a prospect to ask a question regarding a branded product or service;
receiving a question and contact information from the prospect;
selecting a customer associated with the branded product or service to answer the question;
presenting the question to the selected customer through the digital media;
receiving an answer to the question from the selected customer; and
sending the answer to the prospect using the contact information of prospect, where the method is performed by one or more hardware processors.

2. A system comprising:
one or more processors;
memory storing instructions, which, when executed by the one or more processors, causes the one or more processors to perform operations comprising:
presenting an invitation to a prospect to ask a question regarding a branded product or service;
receiving a question and contact information from the prospect;
selecting a customer associated with the branded product or service to answer the question;
presenting the question to the selected customer through the digital media;
receiving an answer to the question from the selected customer; and
sending the answer to the prospect using the contact information of prospect.

3. A non-transitory, computer-readable medium having stored thereon instructions, which, when executed by one or more processors, cause the one or more processors to perform operations comprising:
presenting an invitation to a prospect to ask a question regarding a branded product or service;
receiving a question and contact information from the prospect;
selecting a customer associated with the branded product or service to answer the question;
presenting the question to the selected customer through the digital media;
receiving an answer to the question from the selected customer; and
sending the answer to the prospect using the contact information of prospect.
